(19) United States
(12) Patent Application Publication
(10) Pub. No.: US 2014/0156456 A1
(43) Pub. Date: Jun. 5, 2014

(54) METHOD OF ON-LINE SHOPPING WITH REAL-NAME AUTHENTICATION

(71) Applicant: CATHAY UNITED BANK, Taipei (TW)

(72) Inventor: Jui-Yu WANG, New Taipei City (TW)

(73) Assignee: CATHAY UNITED BANK, Taipei (TW)

(21) Appl. No.: 13/958,089

(22) Filed: Aug. 2, 2013

(30) Foreign Application Priority Data
Nov. 30, 2012 (TW) 101145099

(51) Int. Cl. G06Q 30/06

(52) U.S. Cl. CPC G06Q 30/0609
USPC 705/26.35

(57) ABSTRACT

A method of on-line shopping with real-name authentication includes the steps of:(A) a buyer providing his/her ID number to a real-name authentication bank in order to proceed with the real-name authentication process and obtaining a buyer bank account number; (B) a seller providing its Business Registration Number to the real-name authentication bank in order to proceed with the real-name authentication process and obtaining a seller bank account number; (C) the seller registering a predefined web address in order to proceed with the on-line shopping; (D) the buyer bank account number and his/her ID number being provided to the seller when the buyer purchasing a product or a service with an amount of money in the seller's website; and (E) the seller transmitting the buyer bank account number and the ID number to the real-name authentication bank via the predefined web address.

### CROSS-REFERENCE TO RELATED APPLICATION

This application claims priority from Taiwan Patent Application No. 101145099 filed on Nov. 30, 2012, which is hereby incorporated herein by reference in its entirety.

### FIELD OF THE INVENTION

This invention relates to methods of on-line shopping or service requesting with real-name authentication.

### BACKGROUND OF THE INVENTION

With the booming development of Internet applications, on-line shopping has become the main shopping way for modern people. In conventional on-line shopping, the seller may not receive the money even if the product has been delivered to an anonymous network buyer since an identification of the network buyer does not need to be authenticated. By contrast, a network buyer may not receive the product even if he has paid the money. Moreover, some network users may have several registered accounts for arbitrage and scam. Therefore, more and more on-line shopping websites ask the network buyer or seller to provide their real identity information. This can reduce the above shopping disputes indeed, and however, there comes another problem needs to be concerned that whether the on-line shopping website can safely and effectively keep each personal information. Due to the provided personal information, a network user may suffer huge risks in information leakage. On the other hand, the on-line shopping website is not capable of authenticating the identity information for network users. Thus, even if the on-line shopping websites ask the network users to provide their real identity information, they still might provide fake information.

When a buyer shops products or requests service via a self-service store, an automated vendor machine, etc., the buyer pays by dropping coins or inserting banknotes to the equipments. If the equipments malfunction in sensing coins or banknotes or delivering products normally, both the buyer and the seller are in trouble. Moreover, receiving fake coins or banknotes may cause business loss. Furthermore, the seller needs to periodically collect money in the self-service store, the automated vendor machine, etc. and deposit the cash to the bank so that manpower is quite wasted.

Therefore, there is a need for methods of on-line shopping or service requesting with real-name authentication, which make the seller and buyer finish their deal safely, for reducing the risks of personal information leakage the labor costs for collecting the cash in the self-service store, the automated vendor machine, etc. and the risk for receiving fake coins and banknotes. The present invention meets the need.

### SUMMARY OF THE INVENTION

The objectiveness of the present invention is to provide a method of on-line shopping or service requesting with real-name authentication so that the seller and buyer have a safer way to finish their transactions to reduce the risks for personal information leakage, the labor costs for collecting the cash in the self-service store, the automated vendor machine, etc., and the risk for receiving fake coins and banknotes.

In accordance with one aspect of the invention, there is provided a method of on-line shopping with real-name authentication, comprising the steps of: (A) a buyer providing his/her ID number to a real-name authentication bank in order to proceed with the real-name authentication process and obtaining a buyer bank account number; (B) a seller providing its Business Registration Number to the real-name authentication bank in order to proceed with the real-name authentication process and obtaining a seller bank account number; (C) the seller registering a predefined web address in order to proceed with the on-line shopping; (D) the buyer bank account number and his/her ID number being provided to the seller when the buyer purchasing a product or a service with an amount of money in the seller's website; (E) the seller transmitting the buyer bank account number and the ID number to the real-name authentication bank via the predefined web address; (F) according to the predefined web address, the real-name authentication bank verifying if the source of the seller corresponds to the registered predefined web address; (G) when the predefined web site corresponds to the registered predefined web address, the real-name authentication bank verifying if the buyer bank account number and the ID number are matched; (H) when the buyer bank account number and the ID number are matched, the real-name authentication bank transmitting a request of deduction to the buyer; (I) the buyer agreeing the request of deduct to the real-name authentication bank; (J) when receiving the message that the buyer agrees the request of deduction to the real-name authentication bank, the real-name authentication bank deducting the amount of money in the buyer bank account and remitting it to the seller bank account, and notifying the seller a message that the amount of money is remitted successfully and notifying the buyer a message that the amount of money is deducted successfully; (K) when receiving the message that the amount of money is remitted successfully, the seller sending out the product or providing the service to the buyer.

In accordance with another aspect of the invention, there is provided a method of on-line shopping with real-name authentication, comprising the steps of: (A) a buyer providing his/her ID number to a real-name authentication bank to proceed with the real-name authentication process and obtaining a buyer bank account number; (B) a seller providing its Business Registration Number to the real-name authentication bank to proceed with the real-name authentication process and obtaining a seller bank account number; (C) the seller registering a predefined web address to proceed with the on-line shopping; (D) the buyer bank account number and his/her ID number being provided to the seller when the buyer purchasing a product or a service with an amount of money in the seller's website; (E) the seller transmitting the buyer bank account number to the real-name authentication bank via the predefined web address; (F) according to the predefined web address, the real-name authentication bank verifying if the source of the seller corresponds to the registered predefined web address; (G) when the predefined web site corresponds to the registered predefined web address, the real-name authentication bank verifying the buyer bank account number; (H) when the buyer bank account number is valid, the real-name authentication bank transmitting a request of deduction to the buyer; (I) the buyer agreeing the request of deduct to the real-name authentication bank; (J) when receiving the message that the buyer agrees the request of deduction to the real-name authentication bank, the real-name authentication bank deducting the amount of money in the buyer bank account and remitting it to the seller bank account, and notifying the seller a message that the amount of money is remitted successfully and notifying the buyer a message that the amount of money is deducted successfully; (K) when receiving the message that the amount of money is remitted successfully, the seller sending out the product or providing the service to the buyer.

### BRIEF DESCRIPTION OF DRAWINGS

The objections, functions, features and advantages of the invention will be appreciated more fully from the following further description thereof with reference to the accompanying drawings wherein:

FIG. 1 shows a flow chart of a method of on-line shopping with real-name authentication according to a preferred embodiment of the present invention;

FIG. 2 shows a flow chart of a method of on-line shopping with real-name authentication according to another preferred embodiment of the present invention.

### DETAILED DESCRIPTION OF SPECIFIC EMBODIMENTS

The following exemplary examples will be described in detail with the appended drawings in order to make the aforementioned objectives, functional features, and advantages more clearly understood.

The on-line shopping website refers to a variety of shopping ways connected to the network, such as an on-line computer, an on-line cellar phone, an on-line mobile device, an automated vendor machine, a self-service store (e.g. a kiosk, like 7-11 ibon, FamilyMart FamiPort, Hi-Life Life-ET, OK Mark OK-go) etc.

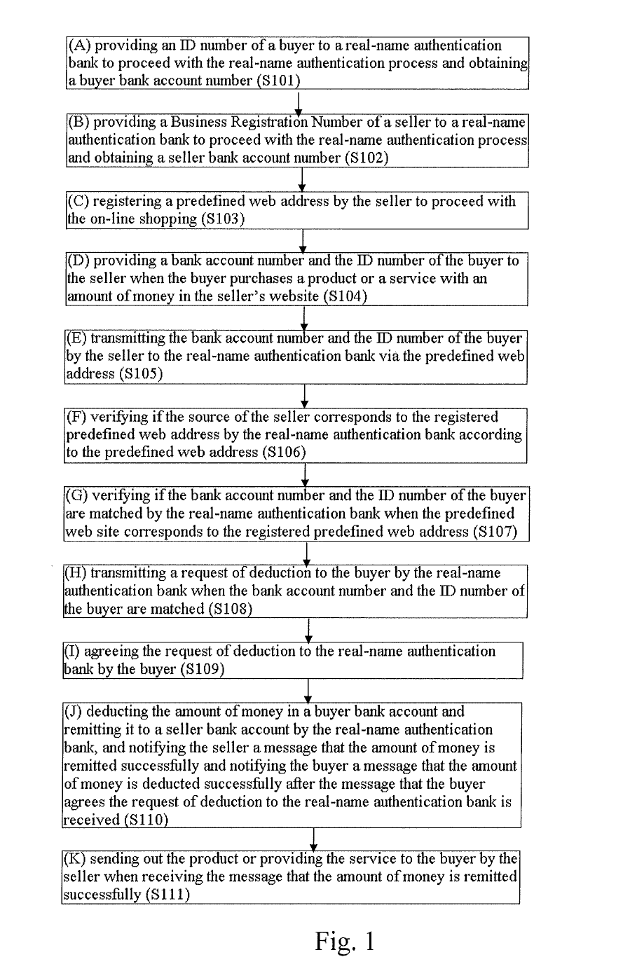

FIG. 1 shows a flow chart of a method of on-line shopping with real-name authentication according to a preferred embodiment of the present invention. In step S101, a buyer provides his/her ID number to a real-name authentication bank in order to proceed with a real-name authentication process and obtains a buyer bank account number. Specifically, the real-name authentication bank authenticates the buyer's identification and provides a buyer bank account number to the buyer once the authentication is completed. In an embodiment of a single-certificate process, the buyer provides one of his/her ID card, national health insurance card, passport, driving license, and student ID card to a real-name authentication bank in order to proceed with the real-name authentication process. In another embodiment of a double-certificate process, the buyer provides his/her ID card and one of national health insurance card, passport, driving license, student ID card to a real-name authentication bank in order to proceed with the real-name authentication process. Further, a triple-certificate process (or more certificates required) may be utilized to proceed with the real-name authentication process. In the real-name authentication process, the real-name authentication bank may record the buyer's contact information, such as phone number, address, etc.

In step S102, a seller provides its Business Registration Number to a real-name authentication bank in order to proceed with a real-name authentication process and obtains a seller bank account number. Specifically, the real-name authentication bank authenticates the seller's identification and provides a seller bank account number to the seller once the authentication is completed. In an embodiment of a single-certificate process, the business owner of the seller provides one of his/her ID card, certificate of company registration, establishment registration form, and registration change form to a real-name authentication bank in order to proceed with the real-name authentication process. In an embodiment of a double-certificate process, the business owner of the seller provides his/her ID card and one of certificate of company registration, establishment registration form, and registration change form to a real-name authentication bank in order to proceed with the real-name authentication process. Further, a triple-certificate process (or more certificates required) may be utilized to proceed with the real-name authentication process. In another embodiment of a single-certificate process, the business owner of the seller provides his/her ID card to a real-name authentication bank in order to proceed with the real-name authentication process. In the real-name authentication process, the real-name authentication bank may record the seller's contact information, such as phone number, address, etc.

In step S103, the seller registers a predefined web address in order to proceed with the on-line shopping. Specifically, the web address of the seller's website is registered to the real-name authentication bank for future authentication. This step can further enhance the security for deal, which will be described in detail in the following steps.

In step S104, when the buyer purchases a product or a service with an amount of money in the seller's website, the buyer bank account number and his/her ID number are provided to the seller. Specifically, the seller obtains the buyer bank account number and his/her ID number.

In step S105, the seller transmits the buyer bank account number and the ID number to the real-name authentication bank via the predefined web address. The predefined web address is the address described in step S103. Via the predefined web address, the seller transmits the information of the buyer bank account number and the ID number to the real-name authentication bank.

In step S106, according to the predefined web address, the real-name authentication bank verifies if the source (i.e., web address) of the seller corresponds to the registered predefined web address. Specifically, the web address that transmitting the information of the buyer bank account number and the ID number should be the same as the web address registered in the real-name authentication bank. This step can further enhance the security for deal. In another embodiment, depending on requirements, there may be a plurality of predefined web addresses.

In step S107, when the predefined web site corresponds to the registered predefined web site, the real-name authentication bank verifies if the buyer bank account number and the ID number are matched. Specifically, the deal is cancelled if the source (i.e., web address) of the seller does not correspond to the registered predefined web address. By contrast, if the source (i.e., web address) of the seller corresponds to the registered predefined web address, then the real-name authentication bank verifies if the buyer bank account number and the ID number are matched. By doing this, the security for deal is enhanced.

In step S108, when the buyer bank account number and the ID number are matched, the real-name authentication bank transmits a request of deduction to the buyer. Specifically, the real-name authentication bank compares “the buyer bank account number and ID number transmitted by the seller” with “the buyer bank account number and ID number that the buyer provided in the real-name authentication process”. Only when two of them are matched, the real-name authentication bank will transmit a request of deduction to the buyer. In an embodiment, the real-name authentication bank transmits a request of deduction to the buyer through a telephone call, facsimile (Fax), mobile phone message, mobile phone APP, or One-Time Password (one time password or dynamic password). In another embodiment, the request of deduction includes the information of the charge amount of the product or service.

In step S109, the buyer agrees the request of deduction to the real-name authentication bank. Specifically, in the condition that the person who received the request of deduction is the person who purchased the product or service, if the information of the product or service shown in the request of deduction (such as, product name, price, amount, etc.) is correct, the buyer should agree the request of deduction.

In step S110, when receiving the message that the buyer agrees the request of deduction to the real-name authentication bank, the real-name authentication bank deducts the amount of money in the buyer bank account and remits it to the seller bank account, and notifies the seller a message that the amount of money is remitted successfully and notifies the buyer a message that the amount of money is deducted successfully. Specifically, since the buyer confirms the transaction and agrees the request of deduction to the real-name authentication bank, the real-name authentication bank may deduct the amount of money in the buyer bank account and remits it to the seller bank account, i.e., transfers the amount of money from the buyer bank account to the seller bank account. And then, the real-name authentication bank notifies the seller a message that the amount of money is remitted successfully and notifies the buyer a message that the amount of money is deducted successfully. That is, the real-name authentication bank notifies both the seller and the buyer that the payment is paid.

In step S111, when receiving the message that the amount of money is remitted successfully, the seller sends out the product or provide the service to the buyer. Specifically, since the amount of money is received, the seller should send out the product or provide the service to the buyer so as to complete the deal.

In the above-mentioned steps, in step S101, the real-name authentication bank knows the buyer's personal information (such as ID number, telephone number, address, etc.). In step S102, the real-name authentication bank knows the seller's personal information (such as Business Registration Number, telephone number, address, etc.). In step S104, the seller knows only the ID number of the buyer but cannot know other information (such as telephone number, address, etc.). In other steps, there is no way that the personal information is leaked. Only the real-name authentication bank acted as the middleman between the buyer and the seller, and knows the personal information and contact information of both them. Therefore, the possibility of the personal information leakage during the shopping process can be reduced to the minimum.

In another embodiment, in step S101, the real-name authentication bank may provide a buyer member account to the buyer. And in step S104, in stead of the ID number, the buyer may provide the buyer member account to the real-name authentication bank. And in step S105, in stead of the ID number, the seller may transmit the buyer member account to the real-name authentication bank. And in the following steps, the use of the ID number may all be replaced by the buyer member account. Thus, the possibility of the personal information leakage can be further reduced.

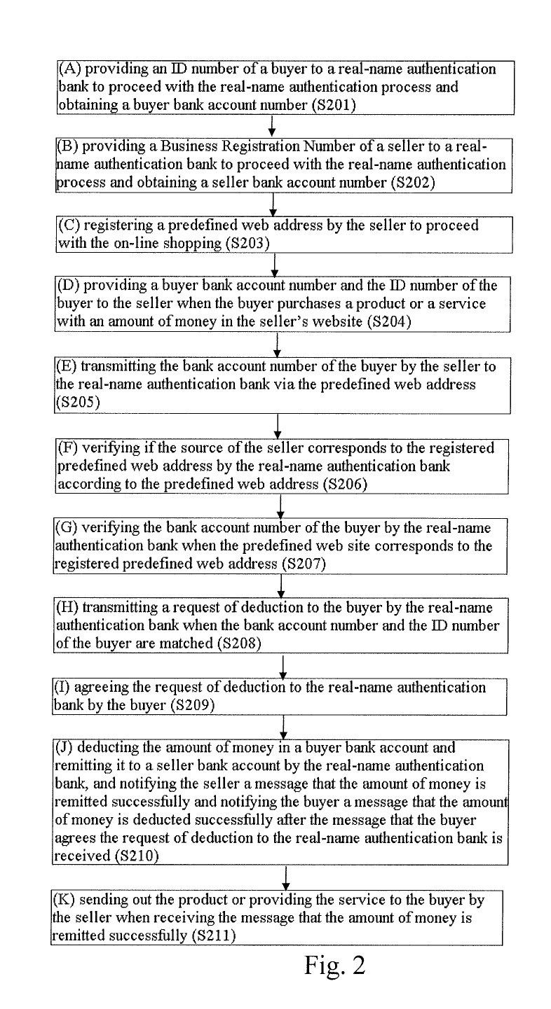

FIG. 2 shows a flow chart of a method of on-line shopping with real-name authentication according to another preferred embodiment of the present invention. This embodiment is mainly directed to a simple consumption mode, such as automated vendor machine. This kind of automated vendor machine can be communicated and connected to the real-name authentication bank via the Internet to proceed with the real-name authentication process. In order to clearly and concisely introduce the present embodiment, only the technical features of it different from that of the embodiment of FIG. 1 are described here. In step S204, when the buyer purchases a product or a service with an amount of money in the seller's website, the buyer bank account number is provided to the seller. In step S205, the seller transmits the buyer bank account number to the real-name authentication bank via the predefined web address. In step S207, when the predefined web site corresponds to the registered predefined web address, the real-name authentication bank verifies the buyer bank account number. Specifically, the real-name authentication bank only needs to verify if the buyer bank account number is valid. In step S208, when the buyer bank account number is valid, the real-name authentication bank transmits a request of deduction to the buyer.

Therefore, the method of on-line shopping or service requesting with real-name authentication of the present invention provides a safer way for the seller and buyer to finish their transactions so as to reduce the risk of personal information leakage and the labor costs for collecting the cash in the self-service store, the automated vendor machine, etc., and the risk for receiving fake coins and banknotes.

While various exemplary embodiments of the present invention are described herein, it should be noted that the present invention may be embodied in other specific forms, including various modifications and improvements, without departing from the spirit and scope of the present invention. Thus, the described embodiments are to be considered in all respects only as illustrative and not restrictive.

What is claimed is:

1. A method of on-line shopping with real-name authentication, comprising the steps of:
(A) providing an ID number of a buyer to a real-name authentication bank to proceed with the real-name authentication process and obtaining a buyer bank account number;
(B) providing a Business Registration Number of a seller to a real-name authentication bank to proceed with the real-name authentication process and obtaining a seller bank account number;
(C) registering a predefined web address by the seller to proceed with the on-line shopping;
(D) providing a bank account number and the ID number of the buyer to the seller when the buyer purchases a product or a service with an amount of money in the seller's website;
(E) transmitting the bank account number and the ID number of the buyer by the seller to the real-name authentication bank via the predefined web address;
(F) verifying if the source of the seller corresponds to the registered predefined web address by the real-name authentication bank according to the predefined web address;
(G) verifying if the bank account number and the ID number of the buyer are matched by the real-name authentication bank when the predefined web site corresponds to the registered predefined web address;
(H) transmitting a request of deduction to the buyer by the real-name authentication bank when the bank account number and the ID number of the buyer are matched;
(I) agreeing the request of deduction to the real-name authentication bank by the buyer;
(J) deducting the amount of money in a buyer bank account and remitting it to a seller bank account by the real-name authentication bank, and notifying the seller a message that the amount of money is remitted successfully and notifying the buyer a message that the amount of money is deducted successfully after the message that the buyer agrees the request of deduction to the real-name authentication bank is received;
(K) sending out the product or providing the service to the buyer by the seller when receiving the message that the amount of money is remitted successfully.

2. The method according to claim 1, wherein the step (A) includes providing an ID card and one of a national health insurance card, a passport, a driving license, and a student ID card of the buyer to a real-name authentication bank in order to proceed with the real-name authentication process and obtaining a buyer bank account number.

3. The method according to claim 1, wherein the step (B) includes providing an ID card and one of certificate of company registration, establishment registration form, and registration change form of a business owner of the seller to a real-name authentication bank in order to proceed with the real-name authentication process and obtaining the seller bank account number.

4. The method according to claim 1, wherein the step (B) includes providing an ID card of a business owner of the seller to a real-name authentication bank to proceed with the real-name authentication process and obtaining the seller bank account number.

5. The method according to claim 1, wherein the step (H) includes transmitting the request of deduction to the buyer by the real-name authentication bank through telephone call, facsimile (Fax), mobile phone message, mobile phone APP, or One-Time Password.

6. The method according to claim 1, wherein the request of deduction includes the information of the amount of money charging for the product or service.

7. A method of on-line shopping with real-name authentication, comprising the steps of:
(A) providing an ID number of a buyer to a real-name authentication bank to proceed with the real-name authentication process and obtaining a buyer bank account number;
(B) providing a Business Registration Number of a seller to a real-name authentication bank to proceed with the real-name authentication process and obtaining a seller bank account number;
(C) registering a predefined web address by the seller to proceed with the on-line shopping;
(D) providing a buyer bank account number and the ID number of the buyer to the seller when the buyer purchases a product or a service with an amount of money in the seller's website;
(E) transmitting the bank account number of the buyer by the seller to the real-name authentication bank via the predefined web address;
(F) verifying if the source of the seller corresponds to the registered predefined web address by the real-name authentication bank according to the predefined web address;
(G) verifying the bank account number of the buyer by the real-name authentication bank when the predefined web site corresponds to the registered predefined web address;
(H) transmitting a request of deduction to the buyer by the real-name authentication bank when the bank account number and the ID number of the buyer are matched;
(I) agreeing the request of deduction to the real-name authentication bank by the buyer;
(J) deducting the amount of money in a buyer bank account and remitting it to a seller bank account by the real-name authentication bank, and notifying the seller a message that the amount of money is remitted successfully and notifying the buyer a message that the amount of money is deducted successfully after the message that the buyer agrees the request of deduction to the real-name authentication bank is received;
(K) sending out the product or providing the service to the buyer by the seller when receiving the message that the amount of money is remitted successfully.
